(19) United States
(12) Patent Application Publication
(10) Pub. No.: US 2008/0128245 A1
(43) Pub. Date: Jun. 5, 2008

(54) Filling installation and a method for conveying receptacles in such an installation

(75) Inventor: Eric Arthaud, Sant Cugat (ES)

Correspondence Address: BIRCH STEWART KOLASCH & BIRCH, PO BOX 747, FALLS CHURCH, VA, 22040-0747, US

(73) Assignee: SERAC GROUP

(21) Appl. No.: 11/987,508

(22) Filed: Nov. 30, 2007

(30) Foreign Application Priority Data
Dec. 1, 2006 (FR) 06 10509

(51) Int. Cl. B65G 47/31

(52) U.S. Cl. 198/419.3

(57) ABSTRACT

The present invention relates to an installation for processing receptacles comprising at least one processing zone receiving a filling device beneath which extends a portion of a receptacles conveyor device comprising:
a first belt going round a first drive pulley and a first driven pulley, both being rotatively mounted about vertical axes, the belt being provided with at least one horizontally-extending receptacle-drive member projecting therefrom,
a second belt going round a second drive pulley and a second driven pulley, both being rotatively mounted about the axes of the pulleys of the first belt so that the belts are superposed, and the second belt being provided with at least one horizontally-extending receptacle-drive member projecting therefrom, and
actuator means for independently actuating the drive pulleys,
a loading zone and an unloading zone being arranged in the vicinity of the pulleys on both sides of the processing zone.

The invention also provides a corresponding conveying method.

The present invention relates to an installation for filling receptacles. The invention also provides method for conveying receptacles in such an installation.

### BACKGROUND OF THE INVENTION

Receptacle conveyor devices are known that comprise a belt going round a drive pulley and a driven pulley, both having vertical axes, and the belt being provided with receptacle drive members projecting horizontally therefrom. The conveyor device is secured to a structure defining a horizontal running track alongside the belt, so that the receptacles stand via their bottoms on the running track and are moved therealong by the drive members when the belt turns.

Proposals have been made to provide a receptacle filler installation with such a conveyor device implanted therein. A filler installation comprises nozzles for delivering fluid each having a weigh member disposed vertically therebeneath. The running track is made up of two segments between which the weigh members are flush, and the belt passes under the nozzles so as to bring the receptacles onto the weigh members under the nozzles. Filling begins when the receptacles are under the nozzles, and it is stopped when a sufficient weight of fluid has been introduced into each of the receptacles. This kind of filling cannot be performed “on the fly”, i.e. without stopping the conveyor device. It is therefore necessary to stop the belt in order to fill each receptacle, and also to separate the drive member from the receptacle while it is being weighed so as to avoid falsifying the measurement. The rate at which such a filler installation operates is thus relatively slow. This makes it difficult to install such an installation in a conventional production line where receptacles would run the risk of accumulating at the entrance to the filler device. Given this low rate of throughput, an installation of the above type can be used only for filling small series of receptacles having small volumes. Using a plurality of juxtaposed filler devices does not provide an effective remedy to those problems.

### OBJECT OF THE INVENTION

An object of the invention is to provide a filling installation having an improved productivity.

### SUMMARY OF THE INVENTION

To this end, the invention provides an installation for processing receptacles comprising at least one processing zone receiving a filling device beneath which extends a portion of a receptacles conveyor device comprising:

a first belt going round a first drive pulley and a first driven pulley, both being rotatively mounted about vertical axes, the belt being provided with at least one horizontally-extending receptacle-drive member projecting therefrom,

a second belt going round a second drive pulley and a second driven pulley, both being rotatively mounted about the axes of the pulleys of the first belt, so that the belts are superposed, and the second belt being provided with at least one horizontally-extending receptacle-drive member projecting therefrom, and

actuator means for independently actuating the drive pulleys,

a loading zone and an unloading zone being arranged in the vicinity of the pulleys on both sides of the processing zone.

Thus, the two belts can be driven at different speeds depending on the position of the drive member relative to reference zones of the device. For example, the first belt may be driven at a speed appropriate for loading and unloading articles, which speed depends in particular on the installations situated upstream from the device, while the second belt can be driven at a speed adapted to performing the filling of the receptacles.

In a first particular embodiment, the belts include a plurality of drive members and, preferably, the drive members of each belt are distributed in at least two groups that are spaced apart by a distance that is not less the length of groups on the other belt.

The groups of drive members on one belt can thus alternate with the groups of drive members on the other belt so that a stream of articles can be driven by the belts in independent groups.

The invention also provides a method of conveying receptacles in an installation of the previous type, the method comprising, for each belt, the steps of:
controlling the drive means to drive each belt at a predetermined speed of advance when the drive member of said belt is in the loading zone and when it is in the unloading zone; and
modifying the speed of advance of the belt when the belt is in the processing zone, the drive means being controlled in such a manner that the drive member of the first belt is offset relative to the drive member of the second belt.

It is thus possible, in the processing zone, to perform the filling of the receptacles at a speed that is different from the loading and unloading speed.

Other characteristics and advantages of the invention appear on reading the following description of particular, non-limiting embodiments of the invention.

### BRIEF DESCRIPTION OF THE DRAWINGS

Reference is made to the accompanying drawings, in which:

FIG. 1 is a diagrammatic plan view of a conveyor device in an installation constituting a first embodiment of the invention;

FIG. 2 is a description view of said installation in section on line II-II of FIG. 1;

FIG. 3 is a diagrammatic elevation view of the installation, after the belt has gone through one-fourth of a revolution;

FIG. 4 is a diagrammatic plan view of a conveyor device in an installation constituting a second embodiment of the invention; and

FIG. 5 is a diagrammatic view of said installation in section on line V-V of FIG. 4.

### DETAILED DESCRIPTION OF THE INVENTION

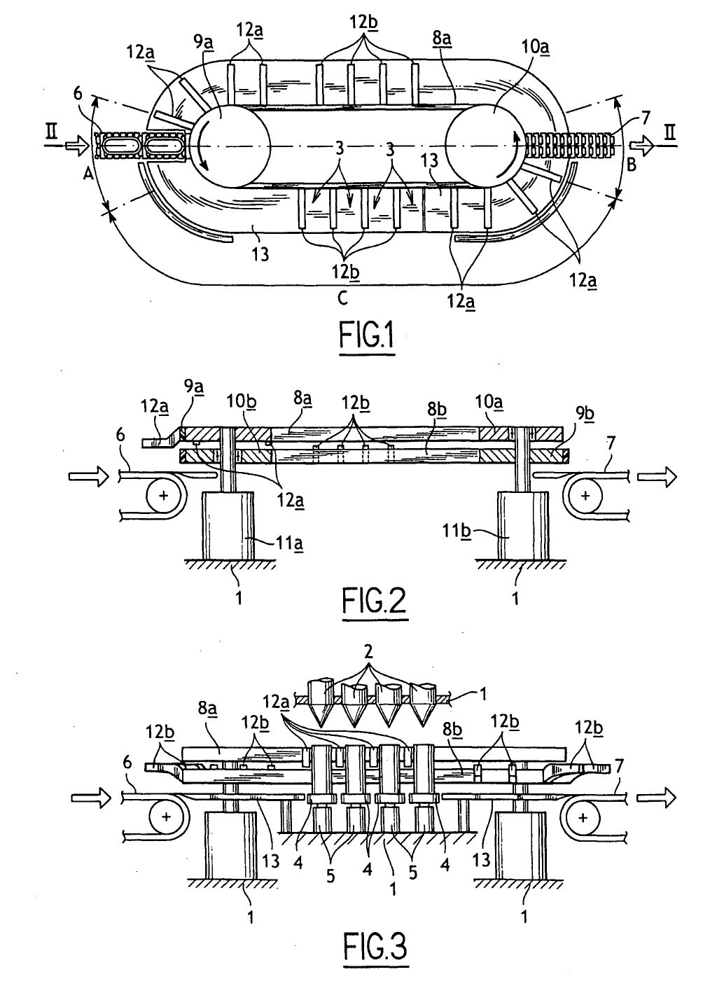

With reference to FIGS. 1 to 3, the processing installation in accordance with the invention, more particularly, a filler installation, comprises a structure 1 having fastened thereon a filler device comprising nozzles 2 for delivering fluid over weigh members or scales 3 each comprising, in conventional manner, a tray 4 associated with a weigh member 5 secured to the structure 1. A linear conveyor 6 and a linear conveyor 7, each known per se, serves to bring receptacles into the filler installation and to remove them from the filler installation. The operation of the nozzles, scales, and linear conveyors is conventional and is not described in detail herein.

Between the linear conveyors 6 and 7 there extends a conveyor device comprising two superposed belts 8a, 8b each going round a drive pulley 9a, 9b and a driven pulley 10a, 10b, the pulleys having vertical axes. The drive pulley 9a is on the same axis as the driven pulley 10b, and the drive pulley 9b is on the same axis as the driven pulley 10a. The drive pulley 9a is constrained to rotate with the outlet shaft of a motor 11a for driving it in rotation, and the drive pulley 9b is constrained to rotate on the outlet shaft of a motor 11b for driving it in rotation. The driven pulley 10b is mounted to rotate freely on the outlet shaft from the motor 11a beneath the drive pulley 9a. The driven pulley 10a is mounted free to rotate on the outlet shaft of the motor 11b above the drive pulley 9b. The motors 11a and 11b are thus secured to the structure 1 under the conveyor device.

The conveyor device has a running track 13 that extends under the belt 8b and comprises two segments disposed on either side of the trays of the scales 3, being flush with the trays 4 and the linear conveyors 6 and 7. The running track may be constituted by a surface having a low coefficient of friction or it may incorporate roller members such as wheels to facilitate moving receptacles thereon.

Receptacle drive members, in this example arms 12a and 12b, extend horizontally projecting from the belt 8a, 8b above the running track 13. The arms 12a, 12b of each belt 8a, 8b are organized in this example in two groups that are spaced apart by a distance greater than the length of the groups of arms 12b and 12a of the other belt 8b, 8a.

The groups of arms 12a, 12b are disposed substantially symmetrically on the belts 8a and 8b. The groups of arms 12a on the belt 8a are offset relative to the groups 12b on the belt 8b so as to extend between the groups 12b of the belt 8b. When one of the groups of arms 12a, 12b is in register with the drive pulley 9a, 9b, the other group of arms 12a, 12b on the same belt extends symmetrically in register with the driven pulley 10a, 10b.

Control zones are defined for the motors 11a and 11b. A loading zone A extends part of the way around the pulleys 9a and 10b, and an unloading zone B extends part of the way around the pulleys 9b and 10a. Between the loading and unloading zones A and B, there is also defined a processing or work zone C that extends upstream and downstream from the filler device.

When an actuator arm 12a, 12b is to be found either in the loading zone A or in the unloading zone B, then the motor 11a, 11b of the corresponding belt is controlled to drive the belt at a speed compatible with the linear conveyors 6 and 7 so as to enable a receptacle to be loaded in front of each arm 12a, 12b and a receptacle to be unloaded from each arm. When all of the arms 12a, 12b are in the working zone C, then the motor 11a, 11b is controlled in such a manner that the belt 8a, 8b brings a receptacle onto the tray 4 of each scale 3, stops, and performs a short reverse movement so as to move away the arm 12a, 12b corresponding to the receptacle. That reverse movement permits to move apart the arms and the receptacles in order to prevent that the contact of the arms with the receptacles beneath the nozzles 2 alters the weighing. Each receptacle is then filled.

Once filling is complete, the motor 11a, 11b is actuated so move the receptacles up to the unloading zone B.

In the working zone C, upstream from the filler device or downstream from the filler device, the speed of the belt 8a, 8b may be greater than or less than its speed in the loading zone A or the unloading zone B, as a function of the operation that is performed in the working zone C. It is thus possible, in the working zone C for the belt to accelerate in order to bring the receptacles into the filler device, to stop, and then to accelerate again in order to remove the receptacles from the filler device prior to decelerating in order to return to the loading/unloading speed.

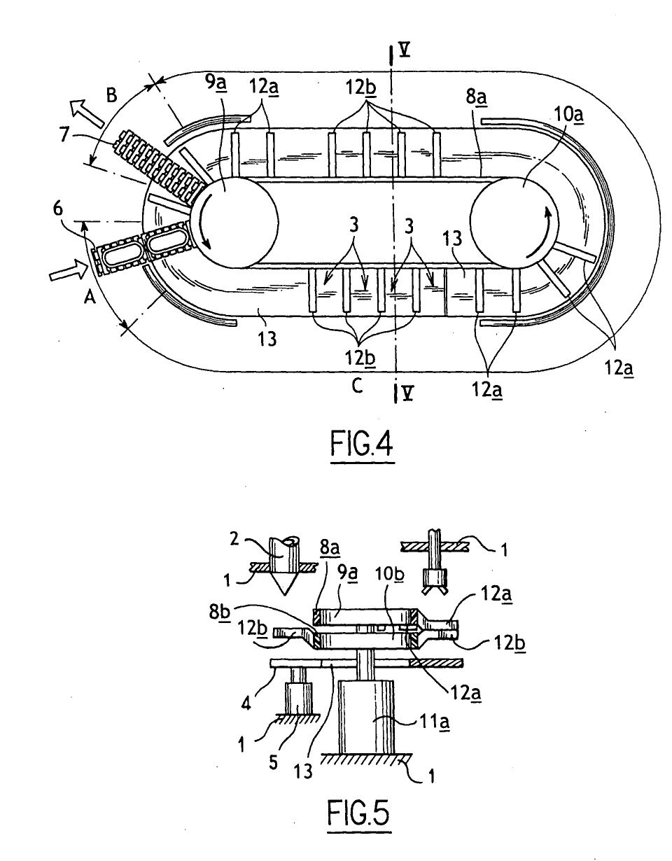

With reference to FIGS. 4 and 5, the conveyor device of the invention is identical in overall structure to that of the conveyor device of FIGS. 1 to 3 and it is described below in association with a filler-closure installation comprising a structure 1 having fastened thereon a filler device identical to that of FIGS. 1 to 3, and also a closure device, known in itself, comprising spindles 14 for putting closures into place on the receptacles. The closure device has as many spindles 14 as the filler device has nozzles 2 and it is placed on the side of the belt 8a, 8b that is opposite from the side on which the filler device is placed, such that when the receptacles are in register with respective nozzles 2 (being moved into this position by groups of drive elements 12b on the belt 8b), other receptacles are in register with respective spindles 14 (brought into position by the other group of drive elements 12b on the same belt 8b).

In this example, the linear conveyors 6 and 7 extend radially in the vicinity of the pulleys 9a and 10b so that the loading zone A and the unloading zone B are adjacent to each other and each of them extends part of the way around the pulleys 9a and 10b. The working zone C thus extends substantially along the rectilinear portions of the belts 8a and 8b and around the pulleys 10a and 9b.

The motors 11a and 11b are controlled in a manner identical to that described above.

Naturally, the invention is not limited to the embodiments described and variant embodiments could be provided without going beyond the ambit of the invention as defined by the claims.

In particular, the term processing is used herein to cover performing any operation on the articles, such as filling, weighing, or closing as described above, and mere accelerated or slowed movement of the articles might constitute such processing.

The conveyor device of the invention may be used whenever it is necessary to have one speed of advance for loading and unloading and at least one other speed of advance between loading and unloading.

In a variant, the motor 11a could be mounted above the drive pulley 9a and the drive motor 11b could be mounted below the drive pulley 9b.

The number of drive arms 12a, 12b could be greater than or less than the number in the described embodiment. These arms may also be disposed in some other number of groups that are disposed symmetrically or otherwise.

In addition, two or more work stations may be located in succession along a given side of the belts, or along two successive or opposite sides thereof. The path followed by the belts could be more complex than that described, e.g. forming a polygon or a U-shape. It is possible to provide additional loading and unloading conveyors. Processing or work zones may extend between one or more loading and/or unloading zones.

The drive members may be constituted by any member suitable for defining a location for receiving an article and for entraining the article with said member, such as pallets, V-shapes, clamps, . . . .

The term “belt” naturally covers any closed-loop element.

What is claimed is:

1. An installation for processing receptacles comprising at least one processing zone receiving a filling device beneath which extends a portion of a receptacles conveyor device comprising:
a first belt going round a first drive pulley and a first driven pulley, both being rotatively mounted about vertical axes, the belt being provided with at least one horizontally-extending receptacle-drive member projecting therefrom,
a second belt going round a second drive pulley and a second driven pulley, both being rotatively mounted about the axes of the pulleys of the first belt so that the belts are superposed, and the second belt being provided with at least one horizontally-extending receptacle-drive member projecting therefrom, and
actuator means for independently actuating the drive pulleys,
a loading zone and an unloading zone being arranged in the vicinity of the pulleys on both sides of the processing zone.

2. An installation according to claim 1, wherein the belts include a plurality of drive members.

3. An installation according to claim 2, wherein the drive members of each belt are distributed in at least two groups being spaced apart by a distance that is not less than a length of the groups on the other belt.

4. An installation according to claim 3, wherein the groups are disposed symmetrically on each belt.

5. An installation according to claim 1, wherein the filler device comprises at least one nozzle beneath which extends a receptacle weighing member.

6. An installation according to claim 1, having a processing device mounted in the vicinity of the belts in the processing zone so that the filler device and the processing device can extend simultaneously in the vicinity of at least one drive member of a given belt.

7. An installation according to claim 6, in which the processing devices are disposed on opposite sides of the belts.

8. An installation according to claim 6, wherein the processing device is a closure device of filled receptacles.

9. A method of conveying receptacles in an installation according to any of the preceding claims, the method comprising, for each belt, the steps of:
controlling the drive means to drive each belt at a predetermined speed of advance when the drive member of said belt is in the loading zone and when it is in the unloading zone; and
modifying the speed of advance of the belt when the belt is in the processing zone,
the drive means being controlled in such a manner that the drive member of the first belt is offset relative to the drive member of the second belt.

10. A method according to claim 9, including, when the drive member of the belt is in the processing zone, causing the belt to stop.

11. A method according to claim 10, including, after the belt has stopped, imparting a limited amount of reverse movement to the belt.
